(19) United States
(12) Patent Application Publication
(10) Pub. No.: US 2007/0196603 A1
(43) Pub. Date: Aug. 23, 2007

(54) Film laminated folding carton and method of forming same

(76) Inventors: Don Schroeder, De Pere, WI (US); Carleton F. Graves, Black Creek, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/358,571

(22) Filed: Feb. 21, 2006

(51) Int. Cl. B32B 37/12; B32B 38/04; B32B 38/14; B32B 37/20; B32B 1/08; B32B 37/00; B65D 5/62

(52) U.S. Cl. 428/34.2; 156/277; 156/269; 156/191; 229/5.84

(57) ABSTRACT

A film laminated folding carton and method of forming such carton utilizes an offset printing technique to create graphic images displayed by the carton. Initially, a continuous roll of lamination film is provided and drawn through an offset printing station that prints a graphic image on at least a first surface of the lamination film. After the graphic image has been applied to the lamination film, the printed lamination film is accumulated on a transfer roll. The accumulated printed lamination film is laminated to a continuous strip of base material. Once the printed lamination film and the base material are laminated together to form a carton stock, the carton stock can be die cut to create a series of carton blanks, each of which can be formed into a film laminated folding carton.

### BACKGROUND OF THE INVENTION

The present invention generally relates to a film laminated folding carton formed from a section of carton stock. More specifically, the present invention relates to a film laminated folding carton and a method of forming the folding carton that includes a graphic image printed on a layer of lamination film by using offset printing techniques prior to the formation of the carton stock.

Presently, many different types of folding cartons exist for packaging various types of products. It is desirable for the folding carton to include some type of graphic image to either advertise the product contained within the carton or provide a more visually appealing appearance for the carton to stimulate product interest. Most folding cartons are formed from paper or paperboard, typically called carton or carrier board. Carrier board is specifically manufactured to be used as carton material and typically includes a smooth white surface that is coated onto the carrier board with a white clay-titanium dioxide-latex mixture. The white surface is added to permit printing and colored graphics on the naturally brown, rough surface of the carrier board. The white outer coating creates a surface that will accept graphic images printed using flexo or gravure printing techniques.

Alternatively, the white outer surface can be provided by laminating a thin layer of high-quality label paper, often referred to as Kraft paper, to a thicker backing material. The white outer surface of the Kraft paper again allows for printing utilizing flexo or gravure printing techniques.

Yet another method of providing a graphic image on a paperboard carton is to utilize a plastic sheet that is bonded onto a layer of paper base material, such as shown and taught by U.S. Pat. No. 4,254,173. As taught by the '173 patent, the plastic material is printed utilizing radiation pre-treatment techniques to ensure the proper bonding of the inks to the plastic layer during printing by a printing press through the use of a rotogravure process. Once the laminated film has been printed, it is immediately adhered to the paper material to form the laminated structure.

Although printing on a laminating film prior to the lamination of the film to a paperboard stock is well known, as shown in the '173 patent, conventional methods utilize printing techniques that are unable to create a crisp, clear and detailed graphic image, such as is possible using offset printing techniques. Therefore, a need exists for a film laminated folding carton that includes visually appealing graphic images that can be high speed printed onto a plastic film that can be later applied to a layer of base material to form carton stock.

### SUMMARY OF THE INVENTION

The present invention is a method for forming a film laminated folding carton that includes a visually appealing graphic image created using an offset printer. The use of an offset printer as compared to other types of printing techniques enhances the appearance of the graphic image contained on the folding carton.

Initially, a continuous supply of a lamination film is drawn from a supply roll. The strip of lamination film is drawn into an offset printer. As the lamination film is drawn into the offset printer, the offset printer prints a graphic image on at least the first surface of the lamination film. While the lamination film is within the offset printer, the offset printer prints directly onto the lamination film without any type of support mechanism adhered to the lamination film.

After the graphic image has been printed onto the lamination film, the lamination film is accumulated onto a transfer roll. The transfer roll thus includes a continuous strip of the printed lamination film. The transfer roll can be moved to a different location for completing the remaining portions of the carton formation method.

After the transfer roll has been moved to the desired location, the continuous strip of the printed lamination film is drawn from the transfer roll. The continuous strip of printed lamination film is drawn over an adhesive supply roll that applies a layer of adhesive to the printed lamination film. Depending upon the orientation of the transfer roll, the adhesive layer is applied to either the first surface that includes the graphic image or the second surface that is opposite the printed graphic image. Alternatively, the adhesive roll used to apply the adhesive can be positioned to selectively apply the adhesive layer to either the first or second surface of the printed lamination film without requiring reorientation of the transfer roll. In either case, the adhesive layer is applied to either the first surface or the second surface of the printed lamination film.

After the adhesive is applied to the desired surface of the printed lamination film, the lamination film is brought into contact with a continuous strip of a base material. Preferably, the printed lamination film and the base material are brought into contact with each other within a laminating nip. However, the printed lamination film and the base material can be combined in other manners. In each case, the layer of adhesive applied to either the first surface or the second surface of the printed lamination film is brought into contact with the top surface of the base material.

When the adhesive layer is applied to the first surface of the printed lamination film, the printed graphic image is sandwiched between the lamination film and the base material such that the printed graphic image is protected. In this embodiment, the lamination film must be transparent such that the graphic image is viewable through the lamination film. Alternatively, if the adhesive layer is applied to the second surface of the printed lamination film, the graphic image contained on the first surface is exposed. Such an embodiment is required where the lamination film is opaque, such as with a metalized or holographic film.

After the carton stock has been formed, the continuous length of carton stock enters into a platen die cutter that cuts the carton stock into the desired shape. After the carton stock has been die cut, the carton blanks are received within a converting station that prepares the cartons for shipment to a third party.

### BRIEF DESCRIPTION OF THE DRAWINGS

The drawings illustrate the best mode presently contemplated in carrying out the invention.

In the drawings:

FIG. 1 is a schematic representation of the process and method of forming the film laminated folding carton of the present invention;

FIG. 2 is a section view of a first embodiment of the carton stock formed utilizing the process of FIG. 1;

FIG. 3 is a section view of a second embodiment of the carton stock formed by the process of FIG. 1; and

FIG. 4 is a perspective view of the film laminated folding carton of the present invention.

### DETAILED DESCRIPTION OF THE INVENTION

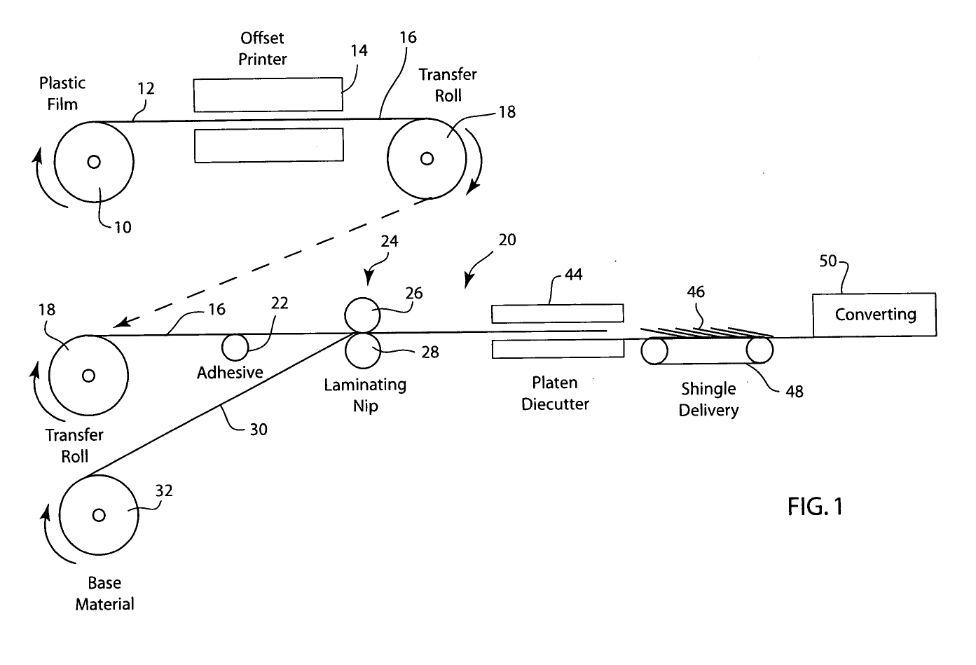

FIG. 1 illustrates a method of forming a film laminated folding carton in accordance with the present invention. As illustrated in FIG. 1, a continuous length of plastic lamination film 12 is drawn from a supply roll 10 and passes through an offset printer 14. The offset printer 14 is a conventional device that is operable to print a four-color graphic image on a first surface of the plastic film 12. The offset printer 14 is able to print the graphic image onto the lamination film 12 as the lamination film 12 passes through the offset printer 14 at a relatively high rate of speed without any additional support for the lamination film 12.

After the graphic image has been applied to the first surface of the lamination film 12, the ink used to create the graphic image is dried within the offset printer 14 and the printed, continuous lamination film 16 is accumulated on a transfer roll 18. Since the offset printer 14 is often located at a different location on-site or even at a remote off-site location from the package forming equipment, the accumulation of the printed lamination film 16 onto the transfer roll 18 allows for the printing of the lamination film 12 to occur at either an off-site printer or a different location within a manufacturing facility.

After the printed lamination film 16 has been accumulated on the transfer roll 18, the transfer roll 18 can be moved to an upstream end of a carton forming line 20. Once the transfer roll 18 is in position, the printed lamination film 16 is drawn from the transfer roll over an adhesive applicator 22. Depending upon the desired carton configuration and the graphic image printed onto the printed lamination film 16, the transfer roll 18 can be oriented such that the adhesive applicator 22 can apply the adhesive to either the first or the second surface of the printed lamination film 16.

After the adhesive has been applied to either the first or second surface of the printed lamination film 16, the printed lamination film enters into a lamination nip 24 including a pair of nip rollers 26, 28. Within the laminating nip 24, the adhesive contained on the printed lamination film is brought into contact with a top surface of a base material 30 drawn from a continuous roll 32.

In the embodiment of the invention illustrated, the base material 30 is preferably a 12-point carrier board having a basis weight of approximately 42 lbs., although other weights and thicknesses for the base material 30 are contemplated as being within the scope of the present invention. The base material 30 can be formed from recycled or virgin pulp depending upon the container requirements. Further, the base material 30 can be formed from a number of different recycled paper products, such as carton board, folding carton board or chip board.

Upon being drawn into the laminating nip 24, the base material 30 is adhered to the printed lamination film 16 to create laminated carton stock 34. As discussed above, depending upon the orientation of the transfer roll 18, either the first surface or the second surface of the printed lamination film is in contact with the base material 30.

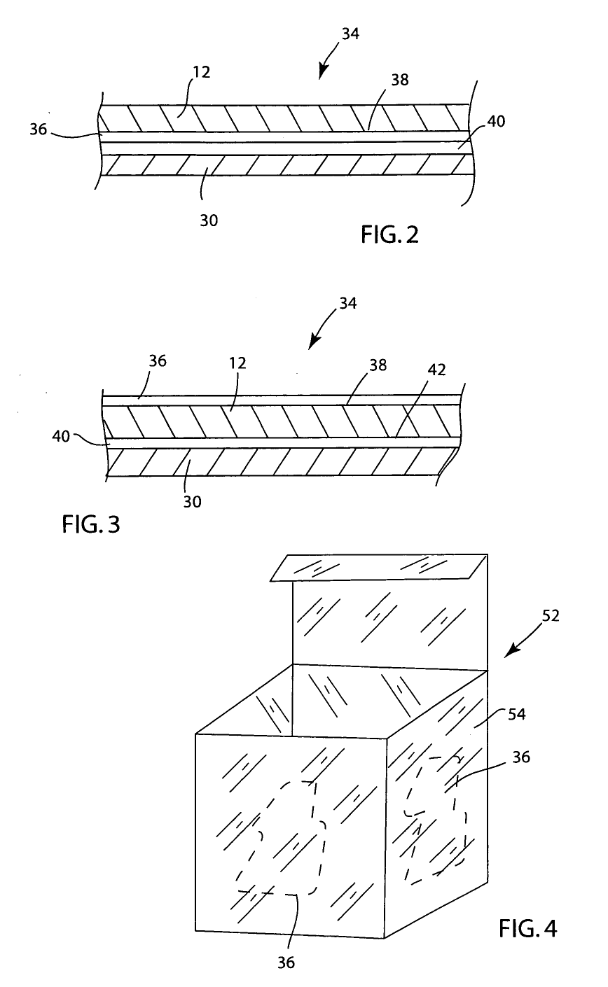

Referring now to FIG. 2, the carton stock 34 in the first embodiment of the invention includes a graphic image 36 printed on the first surface of the lamination film 12 and sandwiched between the lamination film 12 and the base material 30. The adhesive layer 40 adheres the lamination film 12 to the base material 30 and protects the offset printed graphic image 36. The configuration of the carton stock 34 shown in FIG. 2 is particularly desirable where the lamination film 12 is transparent and the graphic image 36 is thus visible through the lamination film 12. As can be understood by the above description, the graphic image 36 is printed onto the first surface 38 in a reverse pattern such that the correct orientation of the graphic image 36 is visible through the transparent lamination film 12. The carton stock 34 shown in FIG. 2 allows the printed graphic image 36 to be protected by the layer of lamination film 12 and the base material 30.

Referring now to FIG. 3, a second embodiment of the carton stock 34 includes the graphic image 36 again printed onto the first surface 38 of the lamination film 12. In this embodiment, however, the adhesive layer 40 is applied to the second surface 42 of the lamination film to adhere the lamination film to the base material 30. This type of configuration is particularly desirable where the lamination film 12 is opaque, such as a metalized or holographic film. In this embodiment, the lamination film 12 is adhered to the base material 30 such that the printed graphic image 36 is viewable from the exterior of the carton stock 34.

Referring back to FIG. 1, after the carton stock 34 has been created by the laminating nip 24, the carton stock is die cut within a platen die cutter 44. The platen die cutter creates separate, individual carton blanks from the continuous strip of carton stock and accumulates the individual carton blanks 46 on a shingle conveyor 48. The shingle conveyor 48 delivers the individual carton blanks to a converting apparatus 50 that applies glue to the proper portions of carton blanks to create the desired carton in a conventional manner.

As shown in FIG. 4, the carton 52 has an outer surface 54 that displays the graphic images 36 created by the offset printing technique during the creation of the carton stock. In the embodiment of the invention illustrated in FIG. 4, the graphic images 36 are positioned between the layer of lamination film and the base material such that the graphic image is protected from damage. However, as described with reference to FIG. 3, the graphic image may be left unprotected if the lamination film is opaque, such as with a metalized or holographic film.

As can be understood by the above description, the use of an offset printer to apply the graphic image to the lamination film 12 as the lamination film is otherwise unsupported within the offset printer 14 allows for the creation of high-quality graphic images on the printed lamination film 16. After the lamination film has been printed, the printed lamination film is accumulated on a transfer roll and can be shipped or moved to a separate, carton forming line. Utilization of an offset printing technique prior to laminating the printed lamination film to a sheet of base material allows for more detailed graphic images to be printed without slowing the process of the package formation. The use of offset printing, as opposed to other printing techniques, allows for a more detailed graphic image to be created and the printer lamination film accumulated for later processing.

I claim:

1. A method of forming a film laminated folding carton comprising the steps of:
providing a continuous roll of a lamination film having a first surface and a second surface;
drawing the lamination film through an offset printing station;
offset printing at least the first surface of the lamination film with an image;
applying an adhesive to the lamination film;
providing a continuous roll of a base material;
laminating the printed lamination film to the base material to form a carton stock; and
die cutting the carton stock into a desired shape for the folding carton.

2. The method of claim 1 wherein the adhesive is applied to the second surface of the lamination film such that the second surface of the lamination film adheres to the base material.

3. The method of claim 2 further comprising the steps of:
rewinding the printed lamination film onto a continuous transfer roll;
transporting the transfer roll to a laminating location; and
unwinding the transfer roll to apply the adhesive to the printed lamination film.

4. The method of claim 1 wherein the adhesive is applied to the first surface of the lamination film such that the first surface of the lamination film contacts the base material such that the image is positioned between the lamination film and the base material.

5. The method of claim 4 further comprising the steps of:
rewinding the printed lamination film onto a continuous transfer roll;
transporting the transfer roll to a laminating location; and
unwinding the transfer roll to apply the adhesive to the printed lamination film.

6. The method of claim 1 wherein the image is offset printed onto the lamination film prior to the lamination of the lamination film to the base material.

7. The method of claim 6 wherein the base material and the printed lamination film are drawn through a lamination nip to laminate the base material to the printed lamination film.

8. The method of claim 4 wherein the lamination film is transparent.

9. The method of claim 1 wherein the lamination film is formed from polyester.

10. The method of claim 1 wherein the base material is a non-corrugated paperboard.

11. A container for enclosing at least one article and providing an outer decorative appearance, the container comprising:
a solid color base material adapted to provide structural support for the container and having an inner surface and an outer surface;
a lamination film having a first surface and a second surface and formed from a plastic material, the first surface being adhered to the outer surface of the base material; and
a decorative image applied to the first surface of the lamination film by an offset printing process, the decorative image being visible through the lamination film.

12. The container of claim 11 wherein the base material is a non-corrugated paperboard.

13. The container of claim 11 wherein the lamination film is bonded continuously to the base material.

14. A method of forming a film laminated folding carton comprising the steps of:
providing a continuous roll of lamination film having a first surface and a second surface;
drawing the lamination film through an offset printing station;
offset printing at least the first surface of the lamination film with a graphic image;
rewinding the printed lamination film onto a continuous transfer roll;
providing a continuous roll of a base material;
unwinding the transfer roll and applying an adhesive to the lamination film;
drawing the base material and the printed lamination film through a lamination nip to laminate the printed lamination film to the base material to form a carton stock; and
die cutting the carton stock into a desired shape for the folding carton.

15. The method of claim 14 wherein the adhesive is applied to the second surface of the lamination film such that the second surface of the lamination film contacts the base material.

16. The method of claim 14 wherein the adhesive is applied to the first surface of the lamination film such that the first surface of the lamination film contacts the base material such that the graphic image is positioned between the lamination film and the base material.

17. The method of claim 16 wherein the lamination film is transparent.
